(19) United States
(12) Patent Application Publication
(10) Pub. No.: US 2008/0205208 A1
(43) Pub. Date: Aug. 28, 2008

(54) Optical System With Filtered Push Pull Radial Tracking

(75) Inventors: Ruud Vlutters, Eindhoven (NL); Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,296

(22) PCT Filed: Jun. 2, 2006
(86) PCT No.: PCT/IB2006/051769

§ 371 Date: Dec. 3, 2007

(30) Foreign Application Priority Data
Jun. 6, 2005 (EP) 05104884.1

(51) Int. Cl. G11B 7/00

(52) U.S. Cl. 369/44.13

(57) ABSTRACT

The present invention relates to optical system capable of reproducing information from an optical carrier by a main beam (C) for reading information as readable effects on the carrier, and a first (A) and a second (B) auxiliary beam. The optical system is adapted to direct the main beam (C) and the first (A) and second (B) auxiliary beam onto the carrier so that the main beam is positioned on a first track, and the first and second auxiliary beam are oppositely positioned on a second and a third track. The optical system can adjust a push pull (PP) radial error signal from the main beam by a function; ƒ=ƒ(A, B, C), where the function ƒ is dependent upon adjacently positioned readable effects in the first, second and third track i.e. the local optical environment of the main beam. Therefore a filtering or “cleaning” of the push pull signal is performed depending on the local optical environment of the main beam.

The present invention relates to an optical system for reproducing optically readable effects on an associated optical record carrier and performing push pull radial tracking on the optical record carrier. The invention further relates to a method for reproducing optically readable effects on an associated optical record carrier.

In order to meet the demand of increasing information storage capacity the available optical media, i.e. compact disc (CD), digital versatile disc (DVD) and the Blu-ray Disc (BD), show a constant improvement in storage capacity. In these optical media, the reproduction resolution has hitherto been mostly dominated by the wavelength, λ, of the reproduction light and the numerical aperture (NA) of the optical reproduction apparatus. However, since it is not easy to shorten the wavelength of the reproduction light or to increase the numerical aperture of the corresponding lens system, attempts to increase the recording density has pre-dominantly been focused at improving the recording media and/or the recording/reproduction method.

Presently, the density limit reached by combining a track pitch of 240 nm with a channel bit length of 50 nm has shown that the capacity of the BD-type disc can potentially be increased from the current 23-25-27 GB up to 50 GB per layer of information on the media.

However, increasing the tangential density by reducing the channel bit length even further or by decreasing the radial density by reducing the track pitch (Tₚ) seems to have reached a limit. In particular, on read-only memory (ROM) discs where radial tracking is performed by the single spot differential phase difference (DPD) method the track pitch is limited at around 250 nm as the tracking error signal vanishes because the spatial frequency (in radial direction) exceeds the optical cut-off.

Hence, an optical system with improved radial tracking would be advantageous, and in particular a more efficient and/or reliable optical system would be advantageous.

Accordingly, the invention preferably seeks to mitigate, alleviate or eliminate one or more of the above-mentioned disadvantages singly or in any combination. In particular, it may be seen as an object of the present invention to provide an optical system that solves the above-mentioned problems of the prior art with increasing the radial density even further.

This object and several other objects are obtained in a first aspect of the invention by providing an optical system capable of reproducing information from an associated optical record carrier, the carrier having readable effects arranged in tracks, the optical system comprising:

light providing means for providing at least:

a main beam for reading information as readable effects on the carrier, and

a first and a second auxiliary beam,

photo detection means capable of detecting reflected light from the optical record carrier,

wherein the optical system is adapted to direct the main beam and the first and second auxiliary beam onto the carrier;

the main beam being positioned substantially on a first track, and

the first and second auxiliary beam being oppositely positioned substantially on, or next to, a second and a third track, respectively, the first track being between the second and the third track,

the optical system being adapted to adjust a push pull (PP) radial error signal by a function; ƒ=ƒ(A, B, C), the function ƒ being dependent upon adjacently positioned readable effects in the first, second and third track, and

the optical system further being adapted to perform radial error tracking by application of the push pull (PP) radial error signal adjusted by the adjusting function ƒ.

The invention according to the first aspect is particularly but not exclusively advantageous for facilitating an optical system capable of reproducing information on a carrier with a low track pitch, i.e. track width. This may be obtained due to the selectivity of the adjusting function, ƒ, being dependent on the local optical environment of the main beam. Thus, certain local optical configurations are applied for performing radial tracking while other local optical configurations are not used.

Additionally, the present invention may have improved amplitude of the radial tracking error signal at lower track pitch values as evidenced by empirical/modeling studies. Additionally, the signal to noise ratio have improved due to the selectivity of the adjusting function, ƒ.

The tracks on the optical record carrier are for example in the form of a continuous spiral or in the form of multiple concentric circles.

If the track is in the form of a continuous spiral, it constitutes substantially parallel tracks on the optical record carrier. The spiral track is to be understood as comprising several parallel tracks.

Beneficially, the second and third tracks may be adjacent to the first track, but adjacently readable effect need not—within the context of the present invention—be positioned in adjacent tracks. Thus, application of a third and a fourth auxiliary beam is a natural extension of the principles of the present invention. However, data analysis may be simplified by considering three adjacent tracks.

Advantageously, the tracks of the associated optical record carrier may comprise a portion without grooves. There is particular the case for read-only memory (ROM) format that often do not have a groove for radial tracking. Thus, the present invention may readily be applied for increasing the storage density of this kind of wide spread carriers, e.g. commercial movies on DVD or BD.

In a particular embodiment, the first and second auxiliary beams may be positioned substantially at the same angular position with respect to a center of the associated optical record carrier. This simplifies the subsequent data analysis significantly. However, for spatially separating the reflected light distribution on the photo detection means, the main beam and the first and second auxiliary beams may be shifted relative to each other in the tangential direction. The delays resulting from such shift may be compensated electronically. Additionally, the main beam may be angularly aligned (having same angular position) with respect to a central position on the carrier with the first and second auxiliary beam. Thus, the three spots may be arranged substantially on a line with various orientations on the carrier. This may occur if the light dividing means is e.g. a grating.

The optical system may beneficially be adapted to apply the adjusting function, ƒ(A, B, C) for filtering a first plurality of push pull (PP) radial error signals in the temporal domain to obtain a second plurality of push pull (PP) radial error signals in the temporal domain, i.e. at a lower frequency. Thus, filtering of the first plurality may result in smaller second plurality of signals in order to separate out not appropriate signals. Additionally, the subset of the second plurality of push pull (PP) radial error signals may be averaged before being applied for radial error tracking. The latter improves the signal to noise ratio.

Advantageously, the adjusting function, ƒ(A, B, C), may have a non-zero value only for push pull error signals having a substantially anti-symmetrical shape around a zero radial offset. This is the case for the so-called S-curves, and thus the adjusting function ƒ may be applied for filtering out those push pull error signals that do not have such a pre-determined shape.

In a particular embodiment, the adjusting function, ƒ(A, B, C), may have a non-zero value only when the first (A) and second (B) auxiliary beams simultaneously reflects light from the same kind of readable effect, said readable effect being viewed in a radial direction of the associated carrier, while the main beam (C) does not reflects light from a readable effect. Vice versa, the adjusting function, ƒ(A, B, C), may have a non-zero value only when the first (A) and second (B) auxiliary beams simultaneously does not reflect light from any readable effect while the main beam does reflects light from a readable effect, said readable effect being viewed in a radial direction of the associated carrier. Both conditions provide a symmetric local optical environment as viewed in the radial direction and may have advantageous effects on the resulting push pull signal from the reflected light of the main beam as will be further elaborated below.

In a second aspect, the present invention relates to a method for operating an optical system adapted for reproducing optically readable effects on an associated optical record carrier, the method comprising the steps of

1) providing light providing means for capable of emitting at least:

a main beam for reading information as readable effects on the carrier, and

a first and a second auxiliary beam,

2) providing photo detection means capable of detecting reflected light from the optical record carrier,
3) directing the main beam and the first and second auxiliary beam onto the carrier;

the main beam being positioned substantially on a first track, and

the first and second auxiliary beam being oppositely positioned substantially on, or next to, a second and a third track, respectively, the first track being between the second and the third track,

4) adjusting a push pull (PP) radial error signal by a function; ƒ=ƒ(A, B, C), the function ƒ being dependent upon adjacently positioned readable effects in the first, second and third track, and
5) performing radial error tracking by application of the push pull (PP) radial error signal adjusted by the adjusting function ƒ.

The invention according to the second aspect is particularly, but not exclusively, advantageous for facilitating an improved method for operating optical drives, both for recording (e.g writing) and reproduction (e.g. ROM) of information, because the present invention may be readily implemented as a filtering or “cleaning” step in the data analysis of a push pull signal.

In a third aspect, the invention relates to a computer program product being adapted to enable a computer system comprising at least one computer having data storage means associated therewith to control an optical system according to the second aspect of the invention.

This aspect of the invention is particularly, but not exclusively, advantageous in that the present invention may be implemented by a computer program product enabling a computer system to perform the operations of the second aspect of the invention. Thus, it is contemplated that some known optical system may be changed to operate according to the present invention by installing a computer program product on a computer system controlling the said optical system. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

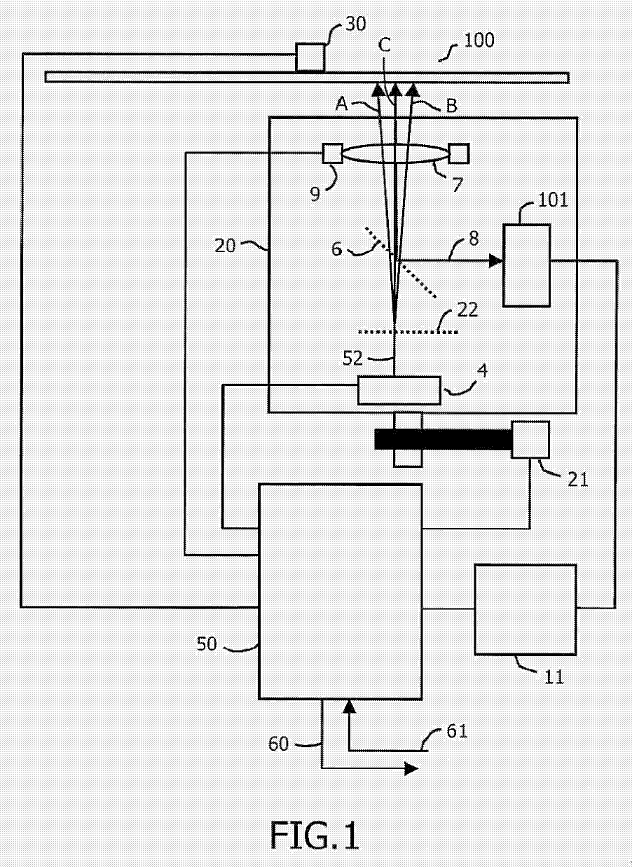

FIG. 1 is a schematic drawing of an optical system according to the first aspect of the invention,

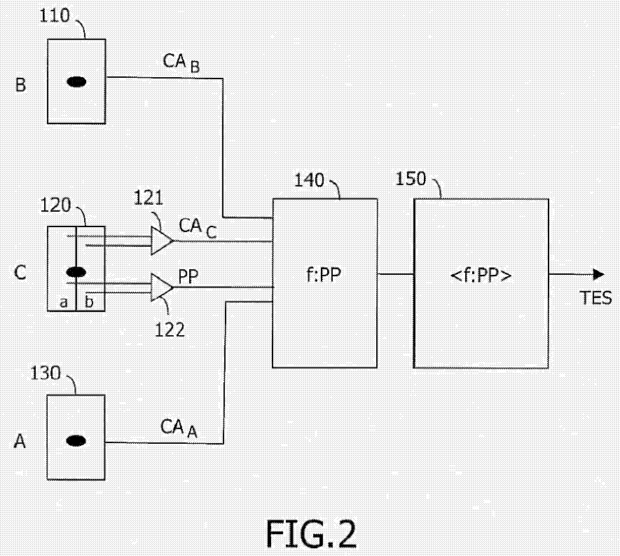

FIG. 2 is a schematic drawing of photo detection means and adjusting means according to the first aspect of the invention,

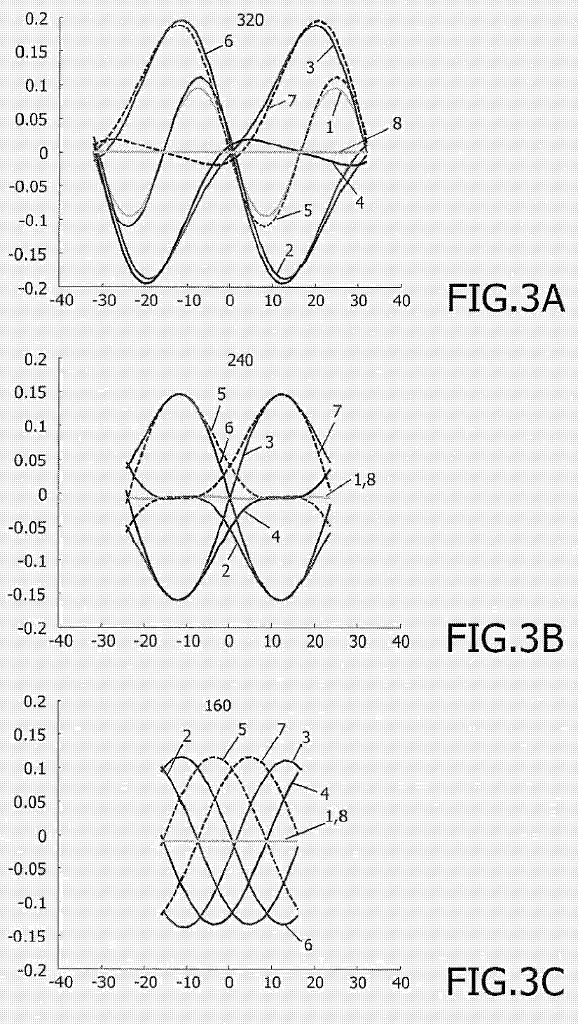

FIGS. 3A, 3B, and 3C show modeling results from three different track pitch values,

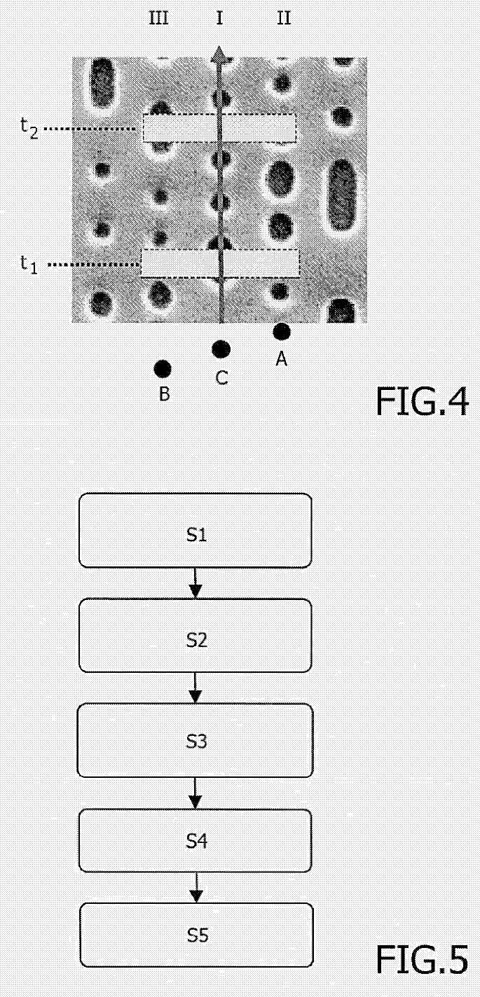

FIG. 4 is a scanning electron microscopy picture of an optical carrier with indications of where the main beam and the auxiliary beams are positioned,

FIG. 5 is a flow-chart of the method according to the second aspect of the invention.

FIG. 1 schematically shows an optical system and associated optical carrier 100 according to the invention. The carrier 100 is fixed and rotated by holding means 30.

The carrier 100 comprises a material suitable for recording information by means of a radiation beam 52. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 100.

The apparatus comprises an optical head 20, sometimes called an optical pick-up (OPU), the optical head 20 being displaceable by actuation means 21, e.g. an electric stepping motor. The optical head 20 comprises a photo detection system 101, a radiation source 4, a beam splitter 6, an objective lens 7, and lens displacement means 9. The optical head 20 also comprises light dividing means 22, such as a grating or a holographic pattern that is capable of splitting the radiation beam 52 into at least three components A, B and C where A and B may denote the first order diffraction on each side of the main beam C. For reason of the clarity the radiation beams A, B, C are shown as triplet single beam after passing through the beam splitting means 22 but more auxiliary spots are typically present if e.g. the light dividing means 22 is a grating. Similarly, the radiation 8 reflected also comprises more than one component, e.g. the reflections of the three spots A, B, and C, and diffractions thereof, but only one beam 8 is shown in FIG. 1 for clarity.

The function of the photo detection system 101 is to convert radiation 8 reflected from the carrier 100 into electrical signals. Thus, the photo detection system 101 comprises several photo detectors, e.g. photodiodes, charged-coupled devices (CCD), etc., capable of generating one or more electric output signals that are transmitted to a pre-processor 11. The photo detectors are arranged spatially to one another, and with a sufficient time resolution so as to enable detection of focus (FE) and radial tracking (RTE) errors in the pre-processor 11. Thus, the pre-processor 11 transmits focus (FE) and radial tracking error (RTE) signals to the processor 50. The photo detection system 101 can also transmit a read signal or RF signal representing the information being read from the carrier 100 to the processor 50 through the pre-processor 11. The read signal may possibly be converted to a central aperture (CA) signal by a low-pass filtering of the RF signal in the processor 50.

The radiation source 4 for emitting a radiation beam 52 can for example be a semiconductor laser with a variable power, possibly also with variable wavelength of radiation. Alternatively, the radiation source 4 may comprise more than one laser. Relevant wavelengths of the radiation source 4 may comprise IR, visible light, UV, and soft X-rays.

The optical head 20 is optically arranged so that the radiation beam 52 is directed to the optical carrier 100 via a beam splitter 6, and an objective lens 7. Additionally, a collimator lens (not shown) may be present before the objective lens 7. Radiation 8 reflected from the carrier 100 is collected by the objective lens 7 and, after passing through the beam splitter 6, falls on a photo detection system 101 which converts the incident radiation 8 to electric output signals as described above.

The processor 50 receives and analyses output signals from the pre-processor 11. The processor 50 can also output control signals to the actuation means 21, the radiation source 4, the lens displacement means 9, the pre-processor 11, and the holding means 30, as illustrated in FIG. 1. Similarly, the processor 50 can receive data, indicated at 61, and the processor 50 may output data from the reading process as indicated at 60.

FIG. 2 is a schematic drawing of photo detection means 101 comprising three photo detector sections 110, 120, 130 for implementing the invention. On each of the photo detector sections 110, 120, 130, the corresponding spot, A, B, and C are shown. In the embodiment shown in FIG. 2, the photo detector section 120 is divided into two photo detectors a and b. This is the normal optical configuration for performing tracking by the push-pull (PP) method, where a relative weighting between the two detectors a and b is applied for generating a radial error signal denoting the error or deviation from an intended radial position and the actual position. For simplicity, only a single spot is shown on the photo detector sections 110, 120, and 130, but typically the first order diffraction lines (m=±1) are present as well. By relative weighting between the detectors marked a and b a push-pull signal PP is obtained by the subtraction circuit 122. The circuit 121 functions as a addition circuit in order to provide a central aperture signal CA_{A} from the photo detector section 120. The circuits 121 and 122 may be positioned in the pre-processor 11. Similarly, from the photo detectors 110 and 130 where the reflections of the auxiliary beams B and A, respectively, are incident two central aperture signals CA_{B} and CA_{A} are obtained. To obtain a useful central aperture (CA) signal from the photo detector sections 110, 120, and 130 it may be necessary to perform a low-pass filtering to have stable output signals.

In FIG. 2, there is also shown adjusting means 140 for applying the filtering or discriminating function ƒ. The function ƒ is dependent upon adjacently positioned readable effects in the first, second and third track in order to filter out push pull signal PP from the photo detector 120 that are not defined as useful according to some pre-determined criteria for subsequently obtaining a tracking error signal TES. Examples of some pre-determined criteria will be given below but the effect of the filtering is essentially to select one or more local optical environments around the main beam C that are suitable for radial error tracking. The function ƒ is dependent on both the neighboring readable effects, e.g. pits, to the main spot C, and on readable effects being read by the main beam C itself; thus

ƒ=ƒ(CA_{A},CA_{B},CA_{C})=ƒ(A,B,C) (1)

Thus, after application of the filtering means only a subset of push pull signals f:PP are left. In the context of the present invention, this subset is defined as first plurality of push pull signals.

In the embodiment shown in FIG. 2, there is additionally installed averaging means 150 to perform an averaging procedure on the subset of filtered push pull signals f:PP resulting in the averaged signal <f:PP>. This is done because push pull signals PP are obtained at the clock frequency of data sampling from the optical carrier 100, and even though the number of push pull signals after filtering, i.e. f:PP, is reduced there may still be a need for a more stabile signal for radial tracking error operation.

In order to illustrate and evidence the principle of the invention, the inventors have performed a comprehensive modeling study with different local optical environments of the main beam C and the resulting effect on the push pull signal PP of the main beam C.

FIGS. 3A, 3B, and 3C show modeling results from three different track pitch values; 320 nm, 240 nm, and 160 nm, respectively. On the horizontal scale is shown the radial tracking offset. Thus, for zero tracking offset the main beam C is located at the intended track. On the vertical scale is plotted the push pull signal PP of the main beam C. For an example of three adjacent tracks the push pull signal PP will respond depending on the pits that are under the non-zero part of the main beam C. Having three tracks with each track having either a pit or an empty space there are 2³=8 different situations that may occur in the radial direction. Notice, that we thereby ignore that pits have varying lengths. In Table 1, below curve numbers of FIGS. 3A-C with corresponding optical configuration are given. Also an example of an adjusting function is given.

TABLE 1

| Curve number | Example of adjusting | Readable effects |
|---|---|---|
| in FIGS. 3A-C | function, f | (1: background, 0: pit) |
| 1 | 0 | [0, 0, 0] |
| 2 | 0 | [0, 0, 1] |
| 3 | 1 | [0, 1, 0] |
| 4 | 0 | [0, 1, 1] |
| 5 | 0 | [1, 0, 0] |
| 6 | −1 | [1, 0, 1] |
| 7 | 0 | [1, 1, 0] |
| 8 | 0 | [1, 1, 1] |

In FIG. 3A with a track pitch of 320 nm, it should be noted that all curves except curves 4, 7 and 8 give rise to push pull signals PP from the main beam C that are anti-symmetrical around zero tracking offset. Thus, effectively curves 1, 2, 3, 5, and 6 represent curves that may be applied for radial tracking as these curves has the so-called “S-curve” shape normally used for radial tracking. At this track pitch, it is possible averaging to add all the curves together and obtain a useful push pull signal as it is conventionally done i.e. without filtering.

Decreasing the track pitch to 240 nm as shown in FIG. 3B, it is only the curves 3 and 6 that have the anti-symmetrical S-shape around zero tracking offset. Thus, the optical configurations [0,1,0] and [1,0,1] corresponding to “pit, land, pit” and oppositely “land, pit, land”, respectively, are preferred for radial tracking error purposes.

Decreasing the track pitch even further to 160 nm as shown in FIG. 3C, demonstrates the same effect i.e. the curves 3 and 6 have an anti-symmetrical S-shape around zero tracking offset, and thus these optical configurations are best suited for radial error tracking by the push pull method also at this low track pitch value. Note that for this low track pitch averaging of all the curves results in a zero signal.

FIG. 4 is a scanning electron microscopy picture of a small portion of an optical carrier of the ROM type. In FIG. 4 are given indications of where the main beam C and the auxiliary beams A and B are positioned when rotating the carrier 100. The moving direction and path of the main beam C is also indicated by the bold arrow in the centre of the SEM picture. Upon rotation of the carrier 100, the main beam C is positioned in a first track I, the first auxiliary beam A is positioned at an adjacent second track II, and the second auxiliary beam B is positioned at an adjacent third track III. The main beam C and the first A and second auxiliary B beams are shifted relative to each other in the tangential direction (in the bold arrow direction). The delays resulting from such shifts are compensated electronically.

At the two different times; t₁ and t₂, the main beam C will have a local optical environment, as viewed in the radial direction, that corresponds to the curves 6 and 3, respectively. To aid the eye two semi-transparent boxes have been added to FIG. 4 to indicate these optical configurations. The purpose of the adjusting function ƒ is therefore to filter out all push pull signals PP obtained from the main beam C expect at the times; t₁ and t₂. Thus, the function ƒ should be only non-zero at the times; t₁ and t₂. Additionally, the adjusting function should perform an inversion of either curve 3 or curve 6 as the two push pull curves have opposite sign, as seen in Table 1. Hence, the adjusting function ƒ(A, B, C) may—in a first model—have simple stepping properties with an approximate values chosen from the group of: −1, 0, or +1, where 0 corresponds to simple discrimination, +1 corresponds to an allowed value and −1 corresponds to an allowed value that needs inverting.

It should be emphasized that more advanced modeling than presented in the present application may be applied in order to exploit not only the curves 3 and 6 shown in the FIGS. 3B and 3C for radial error tracking, but additionally the curves that do not exhibit the aforementioned anti-symmetrical shape around zero radial tracking offset. Such modeling should take into consideration the actual curve shape to obtain a correct tracking error. Nevertheless, such modeling is considered within reach of the skilled person once the principle of the present invention is appreciated. In particular, more advanced method may also apply measures for limiting the inter-symbol interference (ISI) in the tangential direction of the carrier 100.

FIG. 5 is a flow-chart of the method according to the second aspect of the invention. Thus, a method for operating an optical system adapted for reproducing optically readable effects on an associated optical record carrier 100, the method comprising the steps of

S1 providing light providing means 4, 22, 7 capable of emitting at least:

a main beam C for reading information as readable effects on the carrier, and

a first A and a second B auxiliary beam,

S2 providing photo detection means 101 capable of detecting reflected light 8 from the optical record carrier,

S3 directing the main beam C and the first A and second B auxiliary beam onto the carrier;

the main beam being positioned substantially on a first track I, and

the first and second auxiliary beam being oppositely positioned substantially on, or next to, a second II and a third track III, respectively, the first track I being in between the second II and the third track III,

S4 adjusting a push pull radial error signal PP by a function; ƒ=ƒ(A, B, C), the function ƒ being dependent upon adjacently positioned readable effects in the first I, second II and third track III, and

S5 performing radial error tracking by application of the push pull PP radial error signal adjusted by the adjusting function ƒ.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical system capable of reproducing information from an associated optical record carrier, the carrier (100) having readable effects arranged in tracks, the optical system comprising:
light providing means (4, 22, 7) for providing at least:
a main beam (C) for reading information as readable effects on the carrier, and
a first (A) and a second (B) auxiliary beam,
photo detection means (101) capable of detecting reflected light (8) from the optical record carrier,
wherein the optical system is adapted to direct the main beam (C) and the first (A) and second (B) auxiliary beam onto the carrier;
the main beam being positioned substantially on a first track (I), and
the first and second auxiliary beam being oppositely positioned substantially on, or next to, a second (II) and a third track (III), respectively, the first track being between the second and the third track,
the optical system being adapted to adjust a push pull (PP) radial error signal by a function; ƒ=ƒ(A, B, C), the function ƒ being dependent upon adjacently positioned readable effects in the first (I), second (II) and third track (III), and
the optical system further being adapted to perform radial error tracking by application of the push pull (PP) radial error signal adjusted by the adjusting function ƒ.

2. The optical system according to claim 1, wherein the second (II) and third tracks (III) are adjacent to the first track (I).

3. The optical system according to claim 1, wherein the tracks of the associated optical record carrier (100) comprises a portion without grooves.

4. The optical system according to claim 1, wherein the first (A) and second (B) auxiliary beam are positioned substantially at the same angular position with respect to a center of the associated optical record carrier (100).

5. The optical system according to claim 4, wherein the main beam (C) is positioned substantially at the same angular position with respect to a center of the associated optical record carrier (100) as the first and second auxiliary beam.

6. The optical system according to claim 1, wherein the optical system is adapted to apply the adjusting function, ƒ(A, B, C) for filtering a first plurality of push pull (PP) radial error in the temporal domain signals to obtain a second plurality of push pull (PP) radial error signals in the temporal domain.

7. The optical system according to claim 6, wherein at least a subset of the second plurality of push pull (PP) radial error signals is averaged before being applied for radial error tracking.

8. The optical system according to claim 1, wherein the adjusting function, ƒ(A, B, C), has a non-zero value only for push pull error signals having a substantially anti-symmetrical shape around a zero radial offset.

9. The optical system according to claim 1, wherein the adjusting function, ƒ(A, B, C), has a non-zero value only when the first (A) and second (B) auxiliary beams simultaneously reflects light from the same kind of readable effect, said readable effect being viewed in a radial direction of the associated carrier, while the main beam (C) does not reflects light from a readable effect.

10. The optical system according to claim 1, wherein the adjusting function, ƒ(A, B, C), has a non-zero value only when the first (A) and second (B) auxiliary beams simultaneously does not reflect light from any readable effect while the main beam does reflects light from a readable effect, said readable effect being viewed in a radial direction of the associated carrier.

11. A method for operating an optical system adapted for reproducing optically readable effects on an associated optical record carrier (100), the method comprising the steps of
1) providing light providing means for capable of emitting at least:
a main beam (C) for reading information as readable effects on the carrier, and
a first (A) and a second (B) auxiliary beam,
2) providing photo detection means (101) capable of detecting reflected light from the optical record carrier,
3) directing the main beam (C) and the first (A) and second (B) auxiliary beam onto the carrier;
the main beam being positioned substantially on a first track (I), and
the first and second auxiliary beam being oppositely positioned substantially on, or next to, a second (II) and a third track (III), respectively, the first track being between the second and the third track,
4) adjusting a push pull (PP) radial error signal by a function; ƒ=ƒ(A, B, C), the function ƒ being dependent upon adjacently positioned readable effects in the first (I), second (II) and third track (III), and
5) performing radial error tracking by application of the push pull (PP) radial error signal adjusted by the adjusting function ƒ.

12. A computer program product being adapted to enable a computer system comprising at least one computer having data storage means associated therewith to control an optical system according to claim 11.
